(19) United States
(12) Patent Application Publication
(10) Pub. No.: US 2009/0039673 A1
(43) Pub. Date: Feb. 12, 2009

(54) Slide Door Apparatus for Vehicle

(75) Inventors: Ryoichi Fukumoto, Nagoya-shi (JP); Hiroki Okada, Okazaki-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/181,005

(22) Filed: Jul. 28, 2008

(30) Foreign Application Priority Data
Aug. 6, 2007 (JP) 2007-204524

(51) Int. Cl. B60J 5/06

(52) U.S. Cl. 296/155

(57) ABSTRACT

A slide door apparatus for a vehicle includes a reel member disposed at one of a vehicle body and a slide door for opening and closing a door opening formed in the vehicle body and a rope member reeled by the reel member and connected at a terminal end of the rope member to the other of the vehicle body and the slide door. The rope member is unreeled from the reel member so as to rotate the reel member in one direction and reeled within the reel member in accordance with a rotation of the reel member by means of a biasing force in the other direction. The slide door apparatus also includes a rotating device including an internal rotor rotating in accordance with the rotation of the reel member and generating a rotating load depending on a rotating speed of the internal rotor.

### CROSS REFERENCE TO RELATED APPLICATIONS

This application is based on and claims priority under 35 U.S.C. §119 to Japanese Patent Application 2007-204524, filed on Aug. 6, 2007, the entire contents of which is incorporated herein by reference.

### FIELD OF THE INVENTION

The present invention relates to a slide door apparatus for a vehicle.

### BACKGROUND

A conventional slide door for a vehicle is movably supported by a vehicle body so as to open and close a door opening formed in the vehicle body. When placed at positions other than fully closed and opened positions, the slide door is basically released from a mechanical restraint to be in a movable state. Accordingly, for example, when inclination of the vehicle body causes the slide door to start moving due to its weight and slide at a speed exceeding a specified speed, an obstacle may be caught between the slide door and the vehicle body.

In particular, a slide door apparatus for a vehicle disclosed in JP2006-169718A hereinafter referred to as Patent document 1 is configured so that an internal rotor of an oil-filled rotary damper is connected to a wired drum so as to consistently rotate integrally with the wired drum. The internal rotor of the rotary damper rotates along with opening and closing operations of the slide door. In the slide door apparatus, viscosity resistance of oil filled in the rotary damper increases in proportion to a rotating speed of the internal rotor. In this case, when a speed of the slide door is equal to or lower than the specified speed, the rotating speed of the internal rotor of the rotary damper is low and the viscosity resistance of the filled oil acting as a rotating load is also low. Accordingly, manual opening and closing operations of the slide door are not hindered. On the other hand, when the slide door is affected by the inclination of the vehicle body and starts moving due to its weight, a rotating speed of the internal rotor of the rotary damper increases according to an increase of a speed of the slide door, therefore increasing the viscosity of the filled oil acting as the rotating load. Consequently, the speed (exceeding the specified speed) of the slide door is limited, thereby preventing the slide door from suddenly opening and closing. Hereby, sudden opening and closing operations of the slide door are prevented while the manual opening and closing operations of the slide door is not hindered.

Meantime, in the slide door apparatus according to Patent document 1, the viscosity resistance having the above-mentioned characteristics acts in an entire area of the opened and closed positions of the slide door. No obstacle may be caught between the slide door and the vehicle when the slide door is located in an area raging from the fully closed position to a partly opened position not reaching the fully opened position in the case of opening the slide door or when the slide door is located in an area raging from the fully opened position to the partly opened position not reaching the fully closed position in the case of closing the slide door. However, under such conditions, the viscosity resistance of the filled oil acting as the rotating load increases when a speed of the slide door increases, thereby limiting the speed of the slide door. Accordingly, when a user tries to manually open and close the slide door quickly, a speed of the slide door does not increase because of the rotating load generated in the internal rotor. Consequently, the user may feel discomfort because of a hindered movement occurring when opening and closing the slide door. In other words, the user's desire to manually open and close the slide door quickly is not fulfilled.

A need thus exists for a slide door apparatus for a vehicle, which is not susceptible to the drawback mentioned above.

### SUMMARY OF THE INVENTION

According to an aspect of the present invention, a slide door apparatus for a vehicle includes a reel member adapted to be disposed at one of a vehicle body and a slide door for opening and closing a door opening formed in the vehicle body and a rope member reeled by the reel member and adapted to be connected at a terminal end of the rope member to the other of the vehicle body and the slide door. The rope member is unreeled from the reel member when the slide door moves from a predetermined partly opened position to a fully closed position or a fully opened position so as to rotate the reel member in one direction where the reel member unreels the rope member. The rope member is reeled within the reel member in accordance with a rotation of the reel member by means of a biasing force in the other direction where the reel member reels the rope member when the slide door moves from the fully closed position or the fully opened position to the predetermined partly opened position. The slide door apparatus includes a rotating device including an internal rotor rotating in accordance with the rotation of the reel member and generating a rotating load depending on a rotating speed of the internal rotor when the reel member rotates in the one direction where the reel member unreels the rope member.

### BRIEF DESCRIPTION OF THE DRAWINGS

The foregoing and additional features and characteristics of the present invention will become more apparent from the following detailed description considered with reference to the accompanying drawings, wherein:

FIG. 1 is a plan view illustrating a slide door apparatus for a vehicle in a fully closed condition according to a first embodiment of the present invention;

FIG. 2 is a plan view illustrating the slide door apparatus in a fully opened condition according to the first embodiment of the present invention;

FIG. 3 is a cross-sectional view taken along line III-III in FIG. 2;

FIG. 4 is a cross-sectional view taken along line IV-IV in FIG. 3;

FIG. 5 is a cross-sectional view taken along line V-V in FIG. 4;

FIG. 6A is a cross-sectional view taken along line VI-VI in FIG. 4;

FIG. 6B is an enlarged view of a vane portion of a rotating device shown in FIG. 6A;

FIG. 7 is a schematic view illustrating a vehicle to which the slide door apparatus according to the first embodiment is applied;

FIG. 8 is a graph showing a relation between a rotating speed and a rotating load of an internal rotor;

FIG. 9 is a plan view illustrating a slide door apparatus for a vehicle in a fully closed condition according to a second embodiment of the present invention;

FIG. 10 is a plan view illustrating the slide door apparatus in a fully opened condition according to the second embodiment of the present invention;

FIG. 11 is a cross-sectional view taken along line XI-XI in FIG. 10;

FIG. 12 is a cross-sectional view taken along line XII-XII in FIG. 11;

FIG. 13 is a cross-sectional view illustrating a slide door apparatus for a vehicle according to a third embodiment of the present invention;

FIG. 14 is a cross-sectional view illustrating a slide door apparatus for a vehicle according to a fourth embodiment of the present invention; and

FIG. 15 is a cross-sectional view illustrating a slide door apparatus for a vehicle according to a fifth embodiment of the present invention.

### DETAILED DESCRIPTION

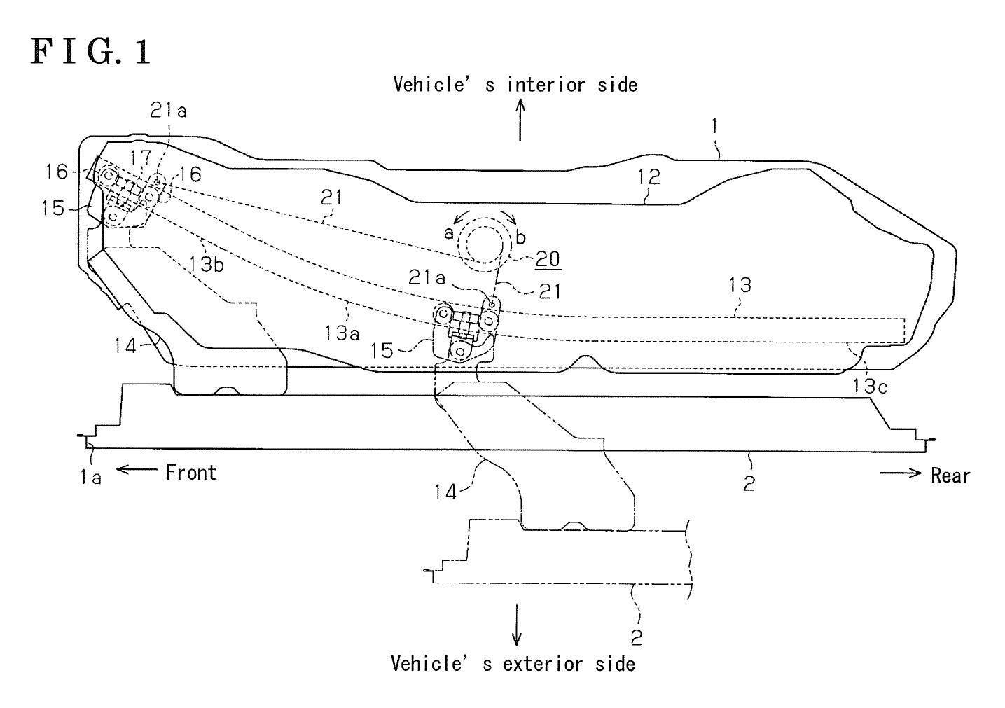

A first embodiment of the present invention will be explained with reference to the illustrations of the figures as follows. FIG. 1 illustrates a slide door apparatus according to the first embodiment. FIG. 7 is a schematic view illustrating a vehicle such as an automobile to which the slide door apparatus is applied. As illustrated in FIG. 7, a vehicle body 1 includes a door opening 1a formed at a lateral side of the vehicle body 1 and a slide door 2 movably supported at the lateral side in a lateral direction of the vehicle. The slide door 2 opens and closes the door opening 1a. In addition, the vehicle body 1 includes a column-shaped pillar 1b and a column-shaped pillar 1c formed at a front side and a rear side of the door opening 1a respectively. In such configuration, an obstacle may be caught between the slide door 2 and the vehicle body 1. For example, in the case of closing the slide door 2, an obstacle may be caught between a front end of the slide door 2 and the pillar 1b. In the case of opening the slide door 2, an obstacle inserted in an opening of a window glass 6 of the slide door 2 while the window glass 6 of the slide door 2 is pulled down may be caught between a window frame 7 and the pillar 1c.

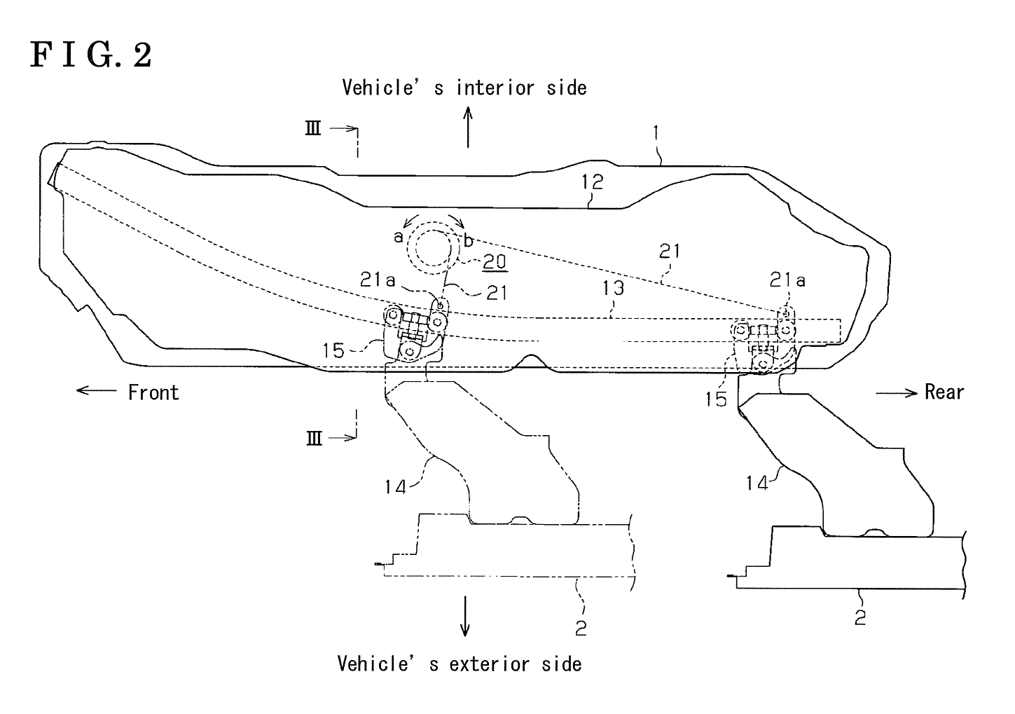

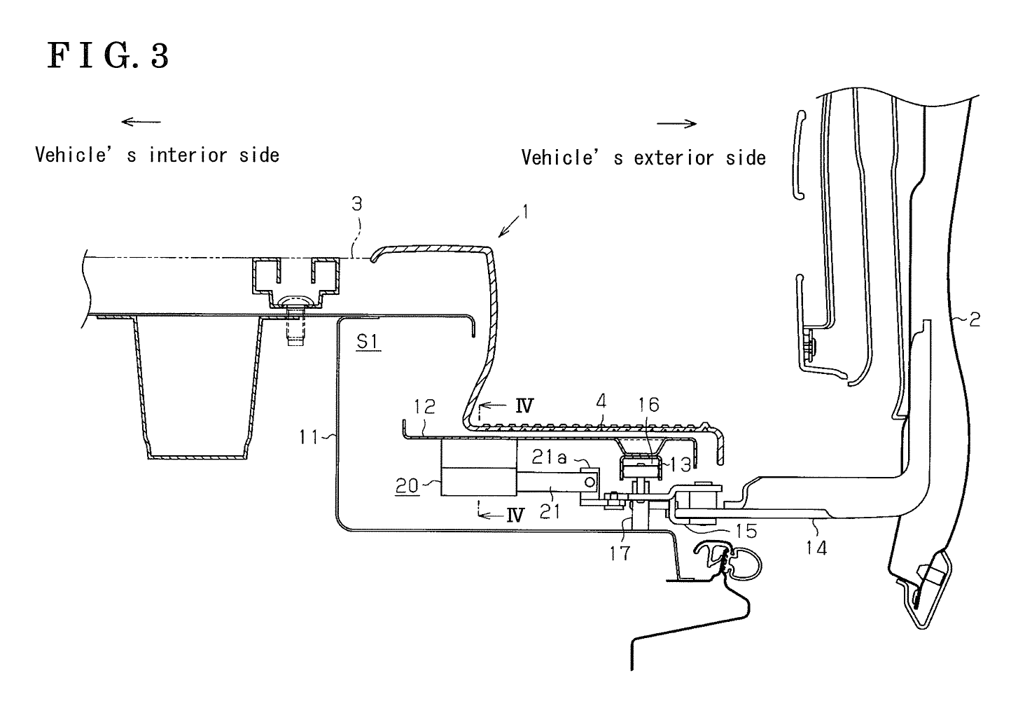

Next, detailed configurations associated with opening and closing operations of the slide door 2 will be explained with reference to FIGS. 1 to 3. FIGS. 1 and 2 are plan views illustrating the slide door 2 located at fully closed and opened positions respectively. In both FIGS. 1 and 2, a predetermined partly opened position of the slide door 2 is shown in chain double-dashed lines. Upper and lower sides seen in FIGS. 1 and 2 correspond to vehicle's interior and exterior sides respectively in a vehicle width direction. Left and right sides seen in FIGS. 1 and 2 correspond to front and rear sides of the vehicle respectively. In addition, FIG. 3 is a cross-sectional view taken along line III-III in FIG. 2.

As illustrated in FIG. 3, a step 4 is formed at the vehicle body 1 so as to be one step lower than a vehicle floor 3 along the door opening 1a. A box-shaped case 11 open to the vehicle's exterior side is fixed to the vehicle body 1 at a lower side of the vehicle floor 3. The case 11 and the step 4 form an accommodating space S1 at the lower side of the vehicle floor 3.

Furthermore, a support panel 12 composed of a metal plate is attached to the vehicle body 1. The support panel 12 extends parallel to the step 4 within the accommodating space S1. Here, both the support panel 12 and the step 4 are disposed so as not to interfere with the slide door 2.

A guide rail 13 composed of a metal plate is fixed to a lower surface of the support panel 12. The guide rail 13 serves for guiding the slide door 2 to open and close. In more detail, as illustrated in FIG. 1, the guide rail 13 includes a first curved portion 13a at an intermediate part of the guide rail 13 in the longitudinal direction of the vehicle. The guide rail 13 includes a second curved portion 13b tilting inwardly toward the vehicle width direction at a front end of the first curved portion 13a and a linear portion 13c extending toward the rear side of the vehicle at a rear end of the first curved portion 13a.

At the same time, an arm 14 protruding toward the vehicle's interior side from the slide door 2 is disposed at a lower side of the slide door 2. A roller supporting member 15 is connected to an end portion of the arm 14 so as to rotate about a rotational axis of the roller supporting member 15 extending in a vertical direction of the vehicle (a direction perpendicular to the paper in FIG. 1). Then, the roller supporting member 15 includes a pair of guide rollers 16 and a load roller 17 disposed between the guide rollers 16. Each of the guide rollers 16 has a rotational axis extending in the vertical direction of the vehicle. The load roller 17 has a rotational axis extending perpendicular to a surface including the rotational axes of both of the guide rollers 16. The roller supporting member 15 is supported by the load roller 17 within the accommodating space S1 so as to roll on the case 11 (vehicle body 1), with the guide rollers 16 mounted in the guide rail 13 so as to rotate therein.

Accordingly, when the guide rollers 16 are guided by the guide rail 13 to move therewithin, the slide door 2 connected to the roller supporting member 15 via the arm 14 slides in the longitudinal direction of the vehicle, therefore opening and closing the door opening 1a. Further, the weight of the slide door 2 is supported by the load roller 17. Especially, the guide rollers 16 are guided by the guide rail 13 in the front end (the inwardly extending portion 13b) of the first curved portion 13a, so that the slide door 2 is pushed out toward the vehicle's exterior side, for example, right after being operated to open from the fully closed position or pushed in toward the vehicle's interior side, for example, right before reaching the fully closed position. Such configuration is provided in order to allow the slide door 2 to slide in a rearward direction when the slide door 2 is operated to open and in order to dispose the slide door 2 to be flush with the lateral side face of the vehicle body 1.

A speed control mechanism 20 for mechanically controlling opening and closing speeds of the slide door 2 is mounted on the lower surface of the support panel 12. The speed control mechanism 20 is located at an intermediate part in the longitudinal direction of the vehicle and more inwardly than the guide rail 13 in the vehicle's interior side. The speed control mechanism 20 includes a strip-shaped rope member 21. A first terminal end 21a of the rope member 21 is rotatably connected to an end portion of the roller supporting member 15. The rope member 21 extends linearly toward the roller supporting member 15 where the first terminal end 21a of the rope member 21 is connected. When the slide door 2 moves from the predetermined partly opened position to the fully closed position or the fully opened position, the rope member 21 is unreeled from within the reel speed control mechanism 20 in accordance with an increase of a distance between the roller supporting member 15 and the speed control mechanism 20. Meanwhile, when the slide door 2 moves from the fully closed position or the fully opened position to the predetermined partly opened position, the rope member 21 is reeled within the speed control mechanism 20 in accordance with a decrease of the distance between the roller supporting member 15 and the speed control mechanism 20 (see FIGS. 1 and 2). Basically, the rope member 21 is configured so as to have the shortest distance between the speed control mechanism 20 and the first terminal end 21a (roller supporting member 15) when the slide door 2 is located at the predetermined partly opened position. That is, the rope member 21 has a sufficient length to connect from the roller supporting member 15 to the speed control mechanism 20 even when the slide door 2 is located at positions (the fully closed and opened positions) where the speed control mechanism 20 and the first terminal end 21a are located farthest away from each other.

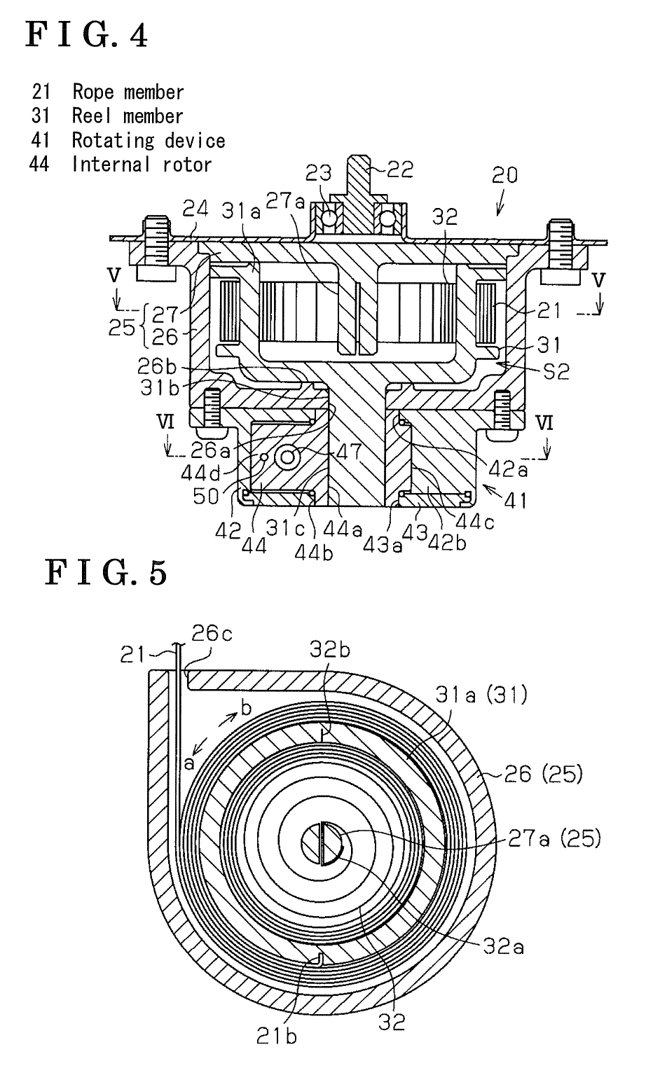

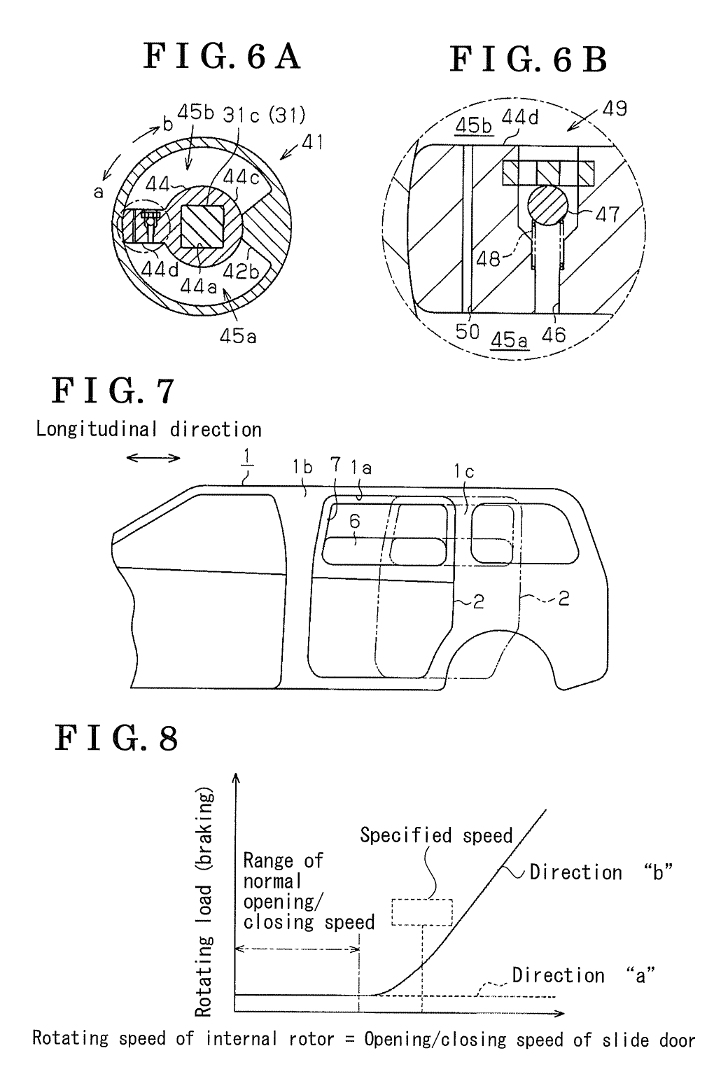

Hereunder, the speed control mechanism 20 will be further explained. FIG. 4 is a cross-sectional view taken along line IV-IV in FIG. 3. FIGS. 5 and 6 are cross-sectional views taken along line V-V and line VI-VI in FIG. 4 respectively.

As illustrated in FIG. 4, a support shaft 22 of the speed control mechanism 20 has a central line extending in the vertical direction of the vehicle. The support shaft 22 is fixed to the support panel 12. A disk-like plate 24 is rotatably supported by the support shaft 22 via bearings 23. A housing 25 is attached to the plate 24. In addition, the housing 25 includes a cylindrical case 26 with a bottom face and a cover 27 closing up an opening of the case 26 while being in contact with the plate 24. The case 26 is fastened to the plate 24. The housing 25 forms an accommodating space S2 at a lower side of the plate 24 (support shaft 22).

A circular bearing hole 26a is formed at the bottom face of the case 26 coaxially with the support shaft 22 so as to penetrate the bottom face of the case 26. An annular slide surface 26b being coaxial with the bearing hole 26 is formed on the bottom face so as to protrude therefrom. Meanwhile, a circular cylindrical shaped column 27a being coaxial with the support shaft 22 is formed at the cover 27 so as to protrude therefrom downwardly toward the accommodating space S2 (the opposite side of the support shaft 22) in the vertical direction of the vehicle.

A reel member 31 accommodated in the housing 25 includes a reel portion 31a, a circular cylindrical shaped shaft portion 31b, and a square pole-like mating shaft portion 31c (see FIG. 6). The reel portion 31a is formed to be a cylindrical shape with a bottom face and coaxially surround the column 27a therewith (with the support shaft 22). The shaft portion 31b protruding from the bottom face of the reel portion 31a is inserted into the bearing hole 26a. The mating shaft portion 31c is provided at an end of the shaft portion 31b located downwardly from the bearing hole 26a in the vertical direction. The bottom face and a circular open end of the reel portion 31a contact the slide surface 26b and the cover 27 respectively, thereby restricting an axial movement of the reel member 31 within the accommodating space S2. The shaft portion 31b is rotatably supported in the bearing hole 26a, thereby rotatably connecting the reel member 31 to the housing 25.

As illustrated in FIG. 5, the rope member 21 is wound around an outer peripheral surface of the reel portion 31a. A second terminal end 21b of the rope member 21 is locked on the outer peripheral surface of the reel portion 31a. When the rope member 21 wound around the reel portion 31a as sited above is unreeled, the reel member 31 rotates in one direction indicated by an arrow “b” (hereinafter referred as to a direction “b”).

Meanwhile, a spiral spring 32 is disposed in an inner circumferential space of the reel portion 31a. A first end 32a of the spring 32 is locked to the column 27a (housing 25) and a second end 32b of the spring 32 is locked to the reel portion 31a (reel member 31). When the rope member 21 wound around the reel portion 31a rotates in the direction “b” where the reel member 31 unreels the rope member 21, the spring 32 stores a rotating force (biasing force) acting in the other direction indicated by an arrow “a” (hereinafter referred to as a direction “a”) where the reel member 31 reels the rope member 21. Accordingly, when the rope member 21 is pushed by the slide door 2 to deflect, the reel portion 31 rotates in the direction “a” due to the biasing force stored by the spring 32, thereby reeling the rope member 21. Consequently, the rope member 21 is prevented from deflecting.

In addition, a mouth 26c for reeling/unreeling in/from the rope member 21 from the case 26 (housing 25) is formed at the case 26 (housing 25). The mouth 26c is pressed by the rope member 21 displaced along with the movement of the slide door 2, thereby rotating the housing 25 around the support shaft 22. Accordingly, the rope member 21 is prevented from extremely deflecting at the mouth 26c.

A rotating device 41 consisting of a pressure resistant rotating damper is attached to the bottom face of the case 26. That is, both the rotating device 41 and the housing 25 are rotatably supported around the support shaft 22 via the bearings 23. The rotating device 41 includes a cylindrical lidded case 42 connected to the case 26 and a cover 43 covering an opening of the case 42 for liquid tight sealing. The rotating device 41 further includes an internal rotor 44 accommodated in an internal space formed by the case 42 and the cover 43.

A bearing hole 42a being coaxial with the bearing hole 26a (shaft portion 31b) is formed in the lid wall of the case 42. The mating shaft portion 31c is freely inserted into the bearing hole 42a. A sector-shaped partition wall 42b is formed in a specified angular range of an inner sidewall of the case 42 so as to protrude toward the center of the rotating device 41. The partition wall 42b has an internal diameter equal to or larger than an internal diameter of the bearing hole 42a. Moreover, a circular bearing hole 43a similar to the bearing hole 42a is formed in the cover 43 so as to be coaxial with the bearing hole 26a (shaft portion 31b). The mating shaft portion 31c is freely inserted into the bearing hole 43a. Further, the internal rotor 44 includes a shaft portion 44b having a square-shaped mating hole 44a and rotatably supported in the bearing holes 42a and 43a for liquid tight sealing. The mating hole 44a mates with the mating shaft portion 31c. The internal rotor 44 includes an approximately cylindrical enlarged diameter portion 44c formed in such a way that the shaft portion 44b is radially enlarged. The enlarged diameter portion 44c slidably contacts an inner circumferential surface of the partition wall 42b. The internal rotor 44 includes a vane portion 44d protruding radially outwardly from the enlarged diameter portion 44c in a specified angular range of the enlarged diameter portion 44c. The vane portion 44d slidably contacts an inner circumferential surface of the case 42.

Accordingly, the internal space formed by the case 42 and the cover 43 is divided by the vane portion 44d in the internal rotor 44. The internal rotor 44 includes a first oil chamber 45a formed at one side of the vane portion 44d (in a counterclockwise direction relative to the vane portion 44d seen in FIG. 6) and a second oil chamber 45b formed at the other side of the vane portion 44d (in a clockwise direction relative to the vane portion 44d seen in FIG. 6). Oil is filled in the first and second oil chambers 45a and 45b. A rotation range (hereinafter referred to as an operational rotating angle) of the internal rotor 44 rotating integrally with the reel member 31 while mating with the mating shaft portion 31c of the reel member 31 is basically limited to a range where the vane portion 44d rotates contacting respective radial inner surfaces of the partition wall 42b as seen FIG. 6A. That is, the operational rotating angle is basically limited to a range smaller than 360 degrees. A diameter of an area where the rope member 21 is reeled (i.e., the reel portion 31a) is configured to be sufficiently large so that an operational rotating angle of the reel member 31 is the same as or less than the operational rotating angle of the internal rotor 44.

As illustrated in an enlarged view of the vane portion 44d of the rotating device 41 of FIG. 6B, an oil passage 46 for communicating between the first oil chamber 45a and the second oil chamber 45b is formed in the vane portion 44d. The vane portion 44d includes a ball 47 disposed close to the second oil chamber 45b for opening the oil passage 46 and a spring 48 biasing the ball 47 in a direction where the ball 47 does not close the oil passage 46. The oil passage 46, the ball 47, and the spring 48 configure a check valve 49. An orifice 50 communicating between the first oil chamber 45a and the second oil chamber 45b is formed next to the check valve 49.

When the internal rotor 44 rotates in the direction “b”, i.e., when the reel member 31 rotates in the direction where the reel member 31 unreels the rope member 21, the ball 47 is pressed by oil flowing from the second oil chamber 45b to the first oil chamber 45a against a biasing force of the spring 48, thereby moving in a direction where the ball 47 closes the oil passage 46. At this time, when a rotating speed of the rotor 44 is within a range of normal opening and closing speeds of the slide door 2, a pressing force of the spring 48 relative to the ball 47 is larger than a pressing force of the oil relative to the ball 47. Accordingly, the check valve 49 is not closed by the ball 47 and oil is scarcely compressed. Consequently, a rotating load (braking) generated by the rotating device 41 undergoes an approximately small constant value.

In addition, when a rotating speed of the internal rotor 44 increases and exceeds the range of the normal opening and closing speeds of the slide door 2, a pressing force of the oil relative to the ball 47 becomes larger than a pressing force of the spring 48 relative to the ball 47. Accordingly, the check valve 49 starts closing. As a result, the oil starts being compressed and a rotating load (braking) generated by the rotating device 41 starts increasing.

Further, when the rotating speed of the internal rotor 44 increases to a specified speed, the pressing force of the oil relative to the ball 47 becomes further larger than the pressing force of the spring 48 relative to the ball 47, and thus the check valve 49 is fully closed by the ball 47. Accordingly, the oil is compressed and a large rotating load occurs. When the volume of the oil flowing from the second oil chamber 45b to the first oil chamber 45a is controlled via the orifice 50, the rotating load increases in proportion to an increase of the rotating speed of the internal rotor 44. In addition, the specified speed is a rotating speed generated in the internal rotor 44 equivalent to maximum opening and closing speeds of the slide door 2 at which a load applied when an obstacle is caught between the slide door 2 and the vehicle body 1 does not extremely increase and remains at a constant level.

On the contrary, when the internal rotor 44 rotates in the direction “a”, i.e., when the reel member 31 rotates in the direction where the reel member 31 reels the rope member 21, the ball 47 does not close the oil passage 46 regardless of a rotating speed of the internal rotor 44 (i.e, the check valve 49 is not closed by the ball 47). Accordingly, a sufficient internal space within the oil passage 46 is secured allowing the oil to flow from the first oil chamber 45a to the second oil chamber 45b. Consequently, a rotating load (braking) generated in the rotating device 41 undergoes the approximately small constant value with little compressed oil.

FIG. 8 is a graph showing a relation between a rotating speed and a rotating load of the internal rotor 44 of the rotating device 41 in each of the directions “a” and “b.” As shown in full lines in FIG. 8, when the internal rotor 44 rotates in the direction “b”, a rotating load (braking) generated in the rotating device 41 undergoes the approximately small constant value under the condition where a rotating speed of the internal rotor 44 is within the range of the normal opening and closing speeds of the slide door 2. Moreover, when the rotating speed of the internal rotor 44 increases and exceeds the range of the normal opening and closing speeds of the slide doors 2, the rotating load (braking) generated in the rotating device 41 starts increasing. Further, when the rotating speed of the rotor 44 increases up to the specified speed, the rotating load (braking) generated by the rotating device 41 increases in proportion to an increase of the rotating speed of the internal rotor 44.

Meanwhile, as shown in dashed lines in FIG. 8, when the internal rotor 44 rotates in the direction “a”, a rotating load (braking) generated in the rotating device 41 undergoes the approximately small constant value regardless of a rotating speed of the rotor 44.

Here, an operation of the slide door 2 according to the first embodiment will be explained as a whole below. As illustrated in FIGS. 1 and 2, when the slide door 2 moves from the predetermined partly opened position to the fully closed position or the fully opened position in accordance with opening and closing operations of the slide door 2, the rope member 21 is unreeled from the reel member 31 along with the opening and closing operations. Further, the reel member 31 rotates in the direction where the reel member 31 unreels the rope member 21, thereby rotating the internal rotor 44 integrally with the reel member 31 in the direction “b.” In this case, when a rotating speed of the internal rotor 44 is low and a speed of the internal rotor 44 is within the range of the normal opening and closing speeds of the slide door 2, a rotating load (braking) generated by the rotating device 41 undergoes the approximately small constant value. Accordingly, the slide door 2 is operated to open and close at a relevant small speed while not being affected by the rotating load.

When the speed of the slide door 2 increases and the rotating speed of the internal rotor 44 starts increasing exceeding the range of the normal opening and closing speeds of the slide door 2, a rotating load generated by the rotating device 41 starts increasing. Further, when the rotating speed of the internal rotor 44 increases up to the specified speed, a rotating load generated in the rotating device 41 increases in proportion to an increase of the rotating speed of the internal rotor 44. The rotating load is transferred to the real member 31 and the rope member 21 and applied to the slide door 2. Accordingly, the slide door 2 is operated to open and close at speeds reduced due to the rotating load so as not to exceed the specified speed.

As described above, when the slide door 2 moves from the predetermined partly opened position to the fully opened position in accordance with an opening operation of the slide door 2 (opening operation), i.e., when an obstacle inserted in the opening of the window glass 6 while the window glass 6 is pulled down may be caught between the window frame 7 and the pillar 1c, the rotating device 41 generates a rotating load depending on the opening speed of the slide door 2 in such a way that the opening speed of the slide door 2 does not excessively increase, and thereby applies the generated rotating load to the slide door 2. Meanwhile, when the slide door 2 moves from the predetermined partly opened position to the fully closed position in accordance with a closing operation of the slide door 2 (closing operation), i.e., when an obstacle may be caught between the front end of the slide door 2 and the pillar 1b, the rotating device 41 generates a rotating load depending on the closing speed of the slide door 2 in such a way that the closing speed of the slide door 2 does not excessively increase, and thereby applies the generated rotating load to the slide door 2.

In addition, even when a rotating load generated in the rotating device 41 is applied to the rope member 21, the rope member 21 basically has sufficient tensile strength to transfer the rotating load to the slide door 2.

On the other hand, when the slide door 2 moves from the fully closed position or the fully opened position to the predetermined partly opened position, the reel member 31 is biased by the spring 32 to rotate in the direction where the reel member 31 reels the rope member 21, thereby rotating the internal rotor 44 in the direction “a”. At this time, a rotating load generated in the rotating device 41 undergoes the approximately small constant value regardless of an opening/closing speed of the slide door 2 (even when the opening/closing speed of the slide door 2 exceeds the specified speed). Accordingly, the slide door 2 is operated to open and close at an approximately constant speed while not being affected by the rotating load. Moreover, the rope member 21 is smoothly reeled in the reel member 31 with the biasing force of the spring 32.

As described above, for example, when the slide door 2 moves from the fully closed position to the predetermined partly opened position in accordance with an opening operation of the slide door 2 (opening operation), i.e., when an obstacle may not be caught between the window frame 7 and the pillar 1c even if the obstacle is inserted in the opening of the window glass 6 while the window glass 6 is pulled down, there is no or slight effect of a rotating load generated in the rotating device 41 regardless of the opening speed of the slide door 2. Accordingly, a user may open the slide door 2 at a speed as he/she intends without his/her manual opening operation of the slide door 2 being hindered. Meanwhile, when the slide door 2 moves from the fully opened position to the predetermined partly opened position in accordance with a closing operation of the slide door 2 (closing operation), i.e., when an obstacle may not be caught between the front end of the slide door 2 and the pillar 1b, there is no or slight effect of a rotating load generated in the rotating device 41 regardless of the closing speed of the slide door 2. Accordingly, the user may close the slide door 2 at a speed as he/she intends without his or her manual closing operation of the slide door 2 being hindered.

In addition, the rope member 21 basically has sufficient bending strength not affecting operation of the slide door even when the rope member 21 is pressed by the slide door 2 to deflect. As described above, the following effects are obtained according to the slide door apparatus according to the first embodiment.

(1) According to the door apparatus of the first embodiment, when the reel member 31 rotates in the direction “b” where the reel member 31 unreels the rope member 21, the rotating device 41 generates an appropriate rotating load to a rotating speed of the internal rotor 44. Accordingly, an increase of opening and closing speeds of the slide door 2 correlating with rotating speeds of the internal rotor 44 is prevented. Consequently, an obstacle may be prevented from being caught between the slide door 2 and the vehicle body 1. Meanwhile, when the reel member 31 rotates in the direction “a” where the reel member 31 reels the rope member 21, there is no or slight effect of a rotating load generated in the rotating device 41. Accordingly, when the slide door 2 moves from the fully closed position or the fully opened position to the predetermined partly opened position, i.e., when no obstacle may be caught between the slide door 2 and the vehicle body 1, opening and closing speeds of the slide door 2 are not reduced. Consequently, when the user manually opens and closes the slide door 2, the slide door 2 is operated to open and close at speeds as he/she intends. As a result, the user's discomfort due to a hindered movement occurring when the slide door 2 is opened and closed may be prevented.

(2) In the first embodiment, the housing 25 is connected to the vehicle body 1 (support panel 12) so as to rotate coaxially with a rotational axis of the reel member 31. Accordingly, the housing 25 is pressed by the rope member 21 to rotate even when the rope member 21 being reeled and unreeled by the reel member 31 interferes with the housing 25 (mouth 26c). Consequently, the rope member 21 is prevented from extremely deflecting at a contact point between the rope member 21 and the housing 25, therefore increasing durability of the rope member 21.

(3) In the first embodiment, the spring 32 is configured to be locked at the first end 32a to the housing 25 as well as at the second end 32b to the reel member 31. The spring 32 having such an extremely simple structure may generate a biasing force acting when the reel member 31 rotates in the direction “a” where the reel member 31 reels the rope member 21.

(4) In the first embodiment, the diameter of the area where the rope member 21 (i.e., the reel portion 31a) is wound is secured to be sufficiently large so that the operational rotating angle of the reel member 31 in accordance with opening and closing operations of the slide door 2 is the same as or less than the operational rotating angle of the internal rotor 44 (smaller than 360 degrees). In addition, the reel member 31 is axially connected directly to the rotating device 41 (internal rotor 44). Accordingly, an area seen when the reel member 31 and the rotating device 44 are axially projected may be reduced.

A second embodiment of the slide door apparatus will be explained with reference to the illustrations of the figures as follows. The second embodiment differs from the first embodiment in that the speed control mechanism 20 is mounted to the slide door 2 instead of the vehicle body 1 (support panel 12). Detailed explanations of similar features of the second embodiment relative to the first embodiment are omitted.

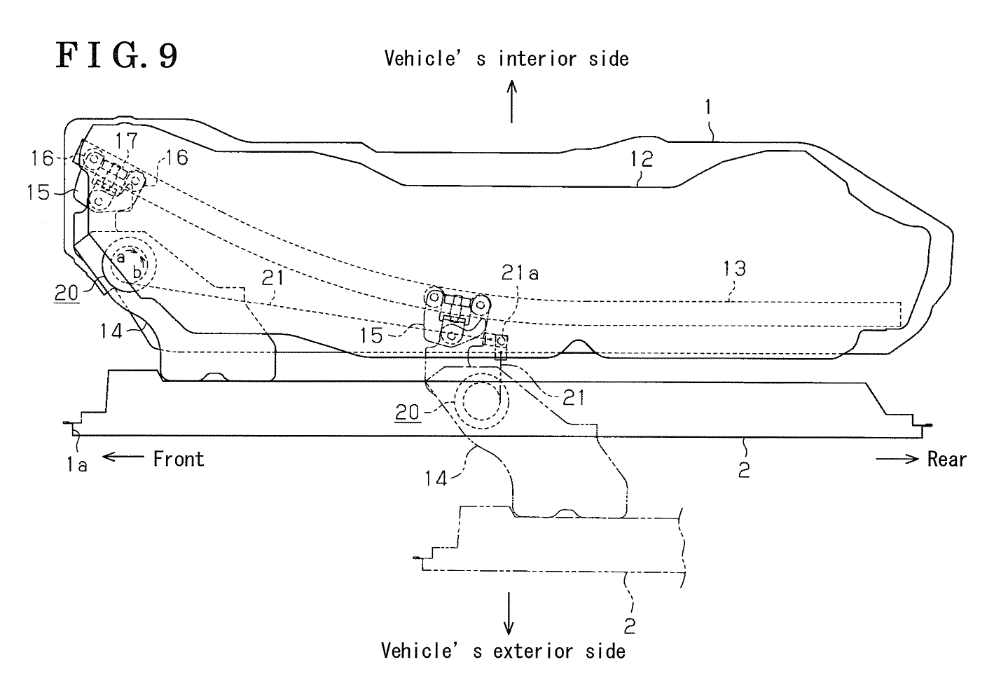

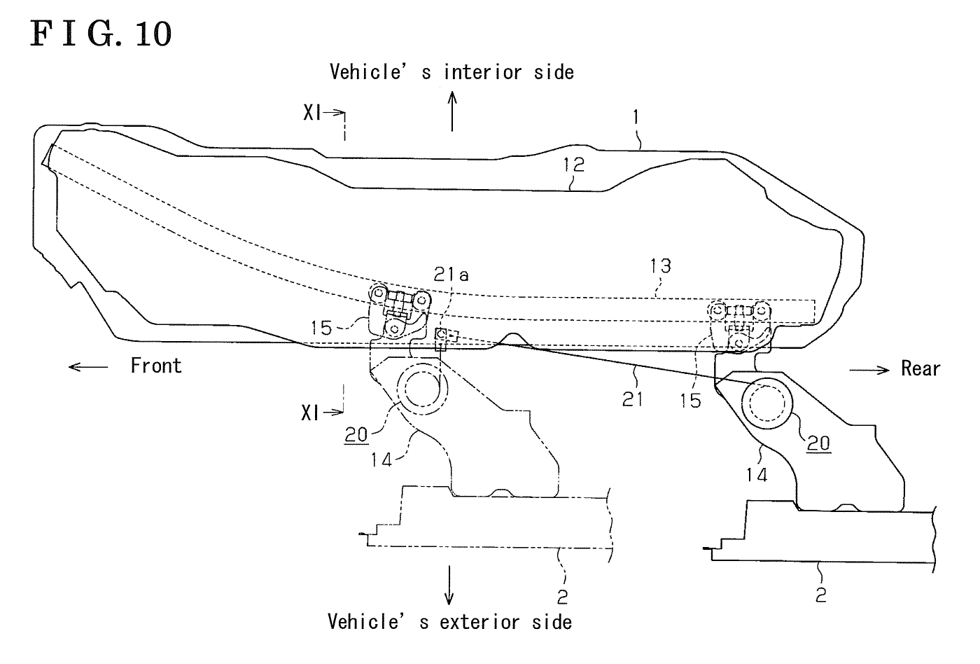

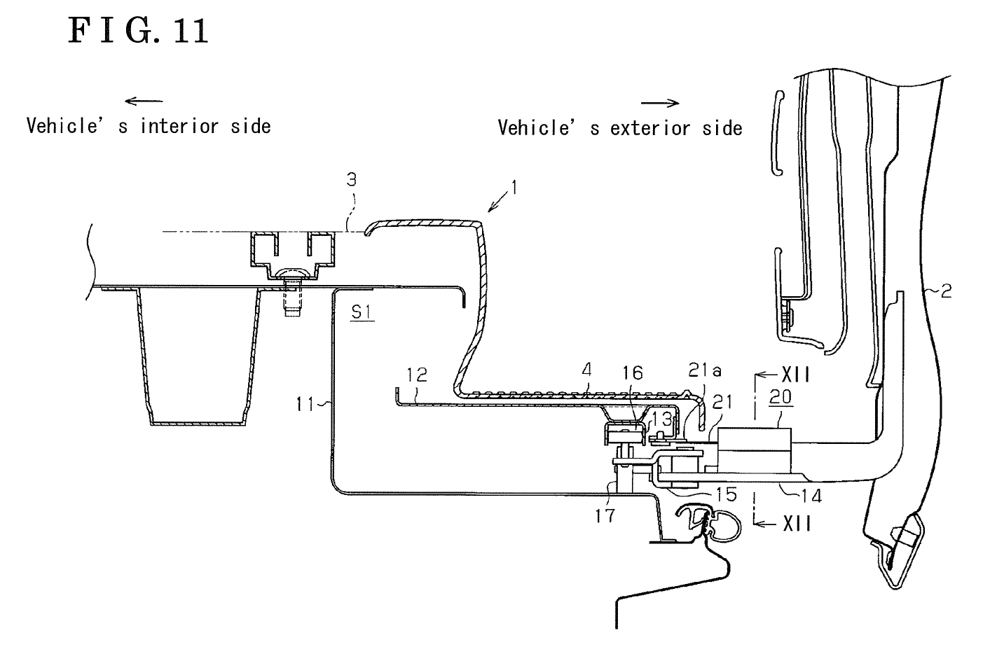

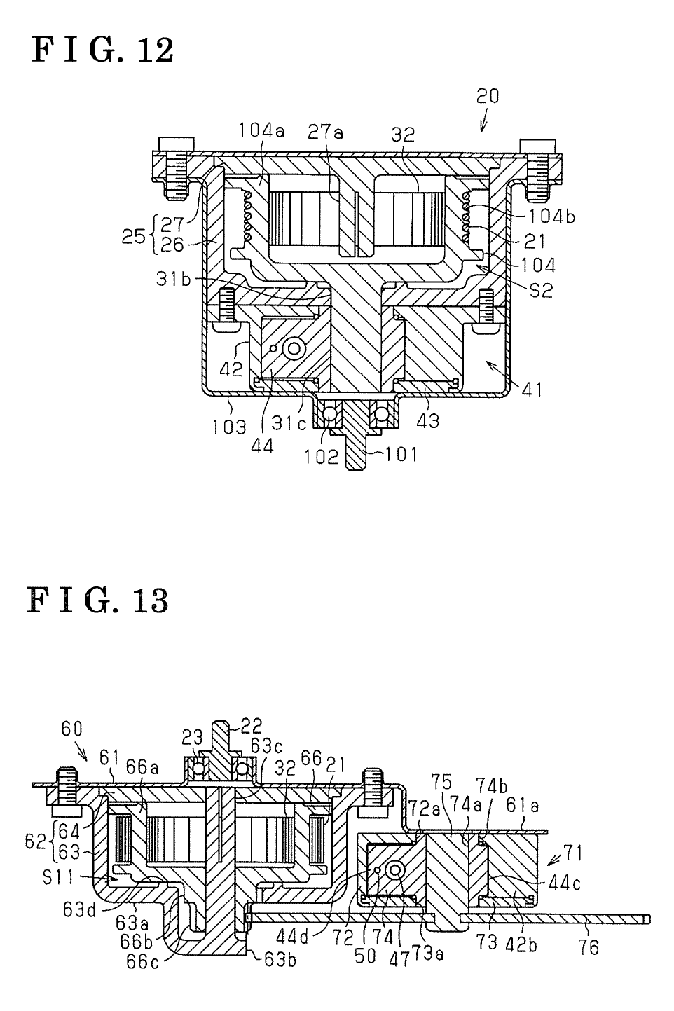

FIGS. 9 and 10 are plan views illustrating the slide door 2 disposed at the fully closed position and the fully opened position, respectively. In both FIGS. 9 and 10, a condition where the slide door 2 is disposed at the predetermined partly opened position is shown in chain double-dashed lines. Furthermore, FIG. 11 is a cross-sectional view taken along line XI-XI in FIG. 10, and FIG. 12 is a cross-sectional view taken along line XII-XII in FIG. 11.

As illustrated in FIG. 11, the speed control mechanism 20 is mounted on an upper surface of the arm 14. The first terminal end 21a of the rope member 21 according to the second embodiment is rotatably connected to the support panel 12 so as to be located more outwardly than the guide rail 13 at the intermediate part in the longitudinal direction of the vehicle. The rope member 21 extends linearly toward the support panel 12 to which the first terminal end 21a is connected. When the slide door 2 moves from the predetermined partly opened position to the fully closed position or the fully opened position, the rope member 21 is unreeled from within the speed control mechanism 20 (a reel member 104). Meanwhile, when the slide door 2 moves from the fully closed position or the fully opened position to the predetermined partly opened position, the rope member 21 is reeled within the speed control mechanism 20 (reel member 104) by the biasing force of the spring 32 (see FIG. 12).

Here, the speed control mechanism 20 of the slide door apparatus according to the second embodiment will be explained. As illustrated in FIG. 12, the speed control mechanism 20 has a support shaft 101 having a central line extending in the vertical direction of the vehicle. The support shaft 101 is fixed to the arm 14. A cylindrical cover 103 with a bottom face is rotatably supported to the support shaft 101 via bearings 102. Both the rotating device 41 and the housing 25 are attached to the cover 103 so as to be accommodated therewithin.

Further, the reel member 104 accommodated in the housing 25 includes a reel portion 104a formed to be a cylindrical shape and having a bottom face. The reel portion 104a surrounds the column 27a (support shaft 101) coaxially therewith and has internal thread-shaped guide grooves 104b on an outer circumferential surface.

The rope member 21 according to the second embodiment is composed of a string-type cable. The rope member 21 is guided by the guide grooves 104b, thereby so that the rope member 21 is reeled by the reel member 104 while being aligned in the guide grooves 104b or unreeled by the reel member 104 from the aligned condition in the guide grooves 104b. Accordingly, the guide grooves 104b enable to smoothly reel/unreel the rope member 21 within/from the speed control mechanism 20.

Configurations and operations of other elements except the speed control mechanism 20 in the second embodiment are the same as those of the first embodiment differing only in that the speed control mechanism 20 is mounted on either the vehicle body 1 (support panel 12) or the slide door 2 (arm 14). Accordingly, detailed explanations of the configurations and operations are omitted.

As described above, in the slide door apparatus according to the second embodiment, the same effects as the first embodiment are obtained. Hereinafter, a third embodiment of the slide door apparatus will be explained with reference to the illustrations of the figures. Detailed explanations of similar features of the third embodiment relative to the first and second embodiments are omitted because the third embodiment differs from the first embodiment or the second embodiment only in a configuration of a speed control mechanism mounted on the vehicle body 1 (support panel 2) or the slide door 2 (arm 14).

FIG. 13 is a cross-sectional view illustrating a speed control mechanism 60 according to the third embodiment. As illustrated in FIG. 13, a plate-like member 61 is rotatably supported to the support shaft 22 via the bearings 23. A housing 62 is attached to the plate-like member 61. In addition, the housing 62 includes a cylindrical stepped case 63 having a bottom face at a base end section and fixed to the plate-like member 61. The housing includes a cover 64 covering an opening of the case 63 while being in contact with the plate-like member 61. Further, the housing 62 forms an accommodating space S11 at a lower side of the plate-like member 61 (support shaft 22).

A step 63a is formed at the case 63 in such a way that the case 63 is expanded radially outwardly via the step 63a. The base end section of the case 63 includes a communicating mouth 63b formed of a cutaway portion at one side in a radial direction (a right side in FIG. 13). Furthermore, the case 63 includes a circular cylindrical shaped column 63c disposed coaxially with the support shaft 22 and protruding from the bottom face of the base end section toward the accommodating space S11 (support shaft 22). In addition, an annular slide surface 63d is formed at the step 63a of the case 63 so as to be disposed concentrically around the support shaft 22 and protrude upwardly toward the accommodating space S11.

A reel member 66 accommodated within the housing 62 includes a cylindrical reel portion 66a with a bottom face, a cylindrical shaft portion 66b protruding from the bottom face of the reel portion 66a, and a gear portion 66c. The reel portion 66a surrounds the column 63c (support shaft 22) concentrically therearound. The column 63c is inserted in both the shaft portion 66b and the bottom face of the reel portion 66a. The gear portion 66c is formed at an end of the shaft portion 66b so as to face the communicating mouth 63b. The bottom face and an annular opening end portion of the reel portion 66a contact the slide surface 63d and the cover 64 respectively, thereby restricting an axial movement of the reel member 66 in the accommodating space S11. The shaft portion 66b of the reel member 66 is rotatably supported by the column 63c, thereby rotatably supporting the reel member 66 by the housing 62.

In the same way as the first and second embodiments, the rope member 21 is wound around an outer peripheral surface of the reel portion 66a. The second terminal end 21b of the rope member 21 is locked on the outer peripheral surface of the reel portion 66a. The spiral spring 32 is disposed in an inner circumferential space of the reel portion 66a. The first end 32a of the spring 32 is locked to the column 63c (housing 62) and the second end 32b of the spring 32 is locked to the reel portion 66a (reel member 66) (see FIG. 5).

The plate-like member 61 includes an extension portion 61a extending outwardly and disposed to be one step lower than a flat surface of the plate-like member 61 on which the support shaft 22 is located in the vertical direction. A rotating device 71 composed of a pressure resistant rotating damper is attached to the extension portion 61a. The rotating device 71 includes a lidded cylindrical case 72 firmly attached to the extension portion 61 of the plate-like member 61 and a cover 73 covering an opening of the case 72 for liquid tight sealing. Furthermore, the rotating device 71 includes an internal rotor 74 accommodated in an internal space formed by the case 72 and the cover 73.

A circular bearing hole 72a is formed in the lid wall of the case 72. The bearing hole 72a is displaced so that a central line of the bearing hole extends parallel to a central line of the column 63c (shaft portion 66b). A bearing hole 73a coaxial with the bearing hole 72a of the case 72 is formed in the cover 73. The bearing hole 73a has a circular shape similar to the bearing hole 72a. Further, a shaft portion 74b is formed in the internal rotor 74. The shaft portion 74b having a square-shaped mating hole 74a is rotatably supported to the bearing holes 72a and 73a for liquid tight sealing.

A square pole-like shaft 75 mates with the mating hole 74a. A gear 76 engaging with the gear portion 66c at the communicating mouth 63b is fixed to an end portion of the shaft 75. The gear 76 is formed so as to have a diameter greater than a diameter of the gear portion 66c. That is, a rotating speed of the reel member 66 is adequately reduced between the gear portion 66c and the gear 76, thereafter being transferred to the internal rotor 74. Accordingly, even when a large diameter of an area (i.e., the reel portion 61a) where the rope member 20 is wound is not secured and an operational rotating angle of the reel member 66 in accordance with opening and closing operations of the slide door 2 is equal to or greater than 360 degrees, a rotation of the internal rotor 74 is limited within an operational rotating angle of the internal rotor 74. Moreover, the rotating device 71 and the reel member 66 are radially disposed side by side with each other, therefore reducing axial thickness of the speed control mechanism 60 as a whole.

As described above, in the slide door apparatus according to the third embodiment, the following effects are obtained in addition to the effects (1) to (3) of the first embodiment. (1) In the third embodiment, even when the operational rotating angle of the reel member 66 in accordance with opening and closing operations of the slide door 2 is equal to or greater than 360 degrees, the rotating speed of the reel member 66 is reduced between the gear portion 66c and the gear 76, thereby limiting the rotation of the internal rotor 74 within the operational rotating angle of the internal rotor 74. Moreover, the axial thickness of the speed control mechanism 60 as a whole is reduced because the rotating device 71 and the reel member 66 are radially disposed side by side with each other.

A fourth embodiment of the slide door apparatus will be explained with reference to the illustrations of the figures as follows. In addition, a rope member having a spring force is applied in the fourth embodiment. Responding to this feature, a speed control mechanism mounted to the vehicle body 1 (support panel 12) or the slide door 2 (arm 14) is modified in the fourth embodiment. This is a different configuration from the configurations of the first, second, and third embodiments. Accordingly, detailed explanations of similar features of other elements of the fourth embodiment to the first, second, and third embodiments are omitted.

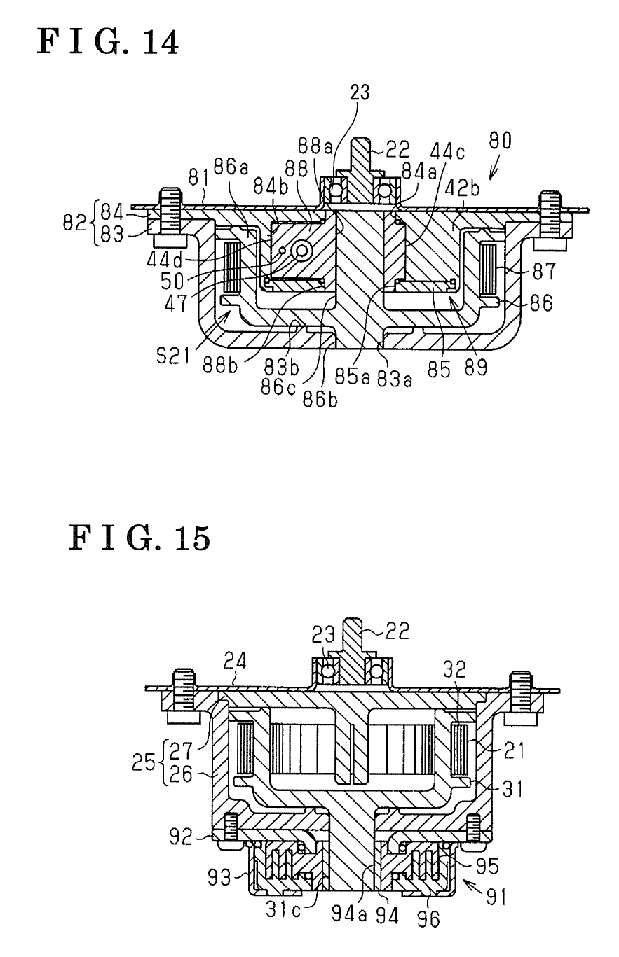

FIG. 14 is a longitudinal cross-sectional view illustrating a speed control mechanism 80 in the slide door apparatus according to the fourth embodiment. As illustrated in FIG. 14, a plate-like member 81 is rotatably supported by the support shaft 22 via the bearings 23. A housing 82 is fixed to the plate-like member 81. In addition, the housing 82 includes a cylindrical case 83 with a bottom face and a cover 84 closing an opening of the case 83 while being in contact with the plate-like member 81.

A circular bearing hole 83a disposed concentrically around the support shaft 22 is formed at the bottom face of the case 83 so as to penetrate the bottom face of the case 83. An annular slide surface 83b disposed concentrically around the bearing hole 83a is formed at the bottom face of the case 83 so as to protrude therefrom. Meanwhile, an annular bearing hole 84a disposed concentrically around the support shaft 22 is formed in the cover 84 so as to penetrate the cover 84. A cylindrical tube 84b located concentrically around the bearing hole 84a is formed at the cover 84 so as to protrude downwardly toward the opposite side of the support shaft 22 in the vertical direction of the vehicle. The cylindrical tube 84b is configured to have an external diameter smaller than an internal diameter of the case 83, thereby forming an accommodating space S21 between the case 83 and the cylindrical tube 84b. In addition, an opening of the cylindrical tube 84b is closed by a cover 85 for liquid-tight sealing. A circular bearing hole 85a similar to the bearing hole 84a is formed in the cover 85.

A reel member 86 accommodated in the housing 82 (accommodating space S21) includes a reel portion 86a, a circular cylindrical shaped shaft portion 86b, and a square pole-like mating shaft portion 86c. The reel portion 86a located concentrically around the bearing hole 83a has a cylindrical shape with a bottom face. The shaft portion 86b is disposed at the bottom face of the reel portion 86a so as to protrude therefrom and to be rotatably supported in the bearing hole 83a. The mating shaft portion 86c coaxial with the shaft portion 86b is disposed at the bottom face of the reel portion 86a and freely inserted in the bearing holes 84a and 85b. The bottom face and a circular open end of the reel portion 86a contact the slide surface 83b and the cover 84 respectively, thereby restricting an axial movement of the reel member 86 within the accommodating space S21. The shaft portion 86b is rotatably supported in the bearing hole 83a, thereby rotatably connecting the reel member 86 to the housing 62.

A rope member 87 is wound around an outer peripheral surface of the reel portion 86a. A first terminal end (21a) of the rope member 87 is rotatably connected to the slide door 2 (arm 14) or the vehicle body 1 (support panel 12). A second terminal end (21b) of the rope member 87 is locked on the outer peripheral surface of the reel portion 86a. The rope member 87 according to the fourth embodiment has its own spring force, thereby generating a biasing force acting when the reel member 86 rotates in the direction “a” where the reel member 86 reels the rope member 87. Accordingly, a biasing member (the spring 32) is not disposed in an inner circumferential space of the reel portion 86a.

An internal rotor 88 accommodated in an internal space formed by the cover 84 (cylindrical tube 84b) and the cover 85 includes a shaft portion 88b having a square-shaped mating hole 88a mating with the mating shaft portion 86c. The shaft portion 88b is rotatably supported in the bearing holes 84a and 85a for liquid tight sealing. The internal rotor 88 rotates integrally with the reel member 86. The internal rotor 88 includes the enlarged diameter portion 44c and the vane portion 44d. The internal rotor 88, the cover 84 (cylindrical tube 84b) including the partition wall 42b, and the cover 85 configure a rotating device 89 composed of a pressure resistant rotating damper. That is, in the slide door apparatus according to the fourth embodiment, the rotating device 89 is disposed in the inner circumferential space of the reel portion 86 of the speed control mechanism 80.

As described above, in the slide door apparatus according to the fourth embodiment, the following effects are obtained in addition to the effects (1), (2), (4) of the first embodiment.

(1) In the fourth embodiment, the rope member 87 generates the biasing force with its own spring force, so that the biasing member (spring 32) is appropriately excluded. Eventually, the slide door apparatus as a whole may be minimized.

(2) In the fourth embodiment, the rotating device 89 is disposed in the inner circumferential space of the reel portion 86a of the speed control mechanism 80, so that the speed control mechanism 80 is minimized in an axial direction. Furthermore, the slide door apparatus as a whole may be minimized.

A fifth embodiment of the slide door apparatus will be explained with reference to the illustrations of the figures. The fifth embodiment differs from the first, second, third, and fourth embodiments in that a rotating device combined with a viscosity resistant rotating damper is applied. Accordingly, detailed explanations of similar features of the fifth embodiment relative to the first, second, third, and fourth embodiments are omitted.

FIG. 15 is a longitudinal cross-sectional view illustrating a speed control mechanism of the slide door apparatus according to the fifth embodiment. As illustrated in FIG. 15, a rotating device 91 composed of a viscosity resistant rotating damper is attached to the bottom face of the case 26. That is, the rotating device 91 is supported by the support shaft 22 so as to rotate together with the housing 25 via the bearings 23. The rotating device 91 includes an annular shaped cover 92 connected to the case 26 and a cylindrical case 93 with a bottom face. The cover 92 has a throttle hole into which the mating shaft portion 31c of the reel member 31 is freely inserted. An opening of the case 93 is closed by the cover 92 for liquid tight sealing. A known one-way clutch 94 is disposed in the case 93. A square-shaped mating hole 94a formed at an inner race of the one-way clutch 94 mates with the mating shaft portion 31c. An internal rotor 95 having a flange portion with a comb-shaped teeth section is fixed to an outer race of the one-way clutch 94 so as to rotate integrally with the reel member 31 in such a way that the internal rotor 95 is accommodated in an internal space formed by the cover 92 and the case 93. The inner and outer races of the one-way clutch 94 are not distinguished for convenience and the one-way clutch 94 as a whole is illustrated in FIG. 14.

The one-way clutch 94 allows rotation of the reel member 31 (mating shaft portion 31c) to be transferred to the internal rotor 95 when the reel member 31 rotates in the direction “b” where the reel member 31 unreels the rope member 21. Meanwhile, the one-way clutch 94 prevents rotation of the reel member 31 (mating shaft portion 31c) from being transferred to the internal rotor 95 when the reel member 31 rotates in the direction “a” where the reel member 31 reels the rope member 21.

Moreover, a sheet 96 having comb-shaped tooth sections is accommodated in the internal space formed by the cover 92 and the case 93. The sheet 96 is fixed to the case 93 by engaging the comb-shaped tooth sections of the sheet 96 with the comb-shaped tooth sections of the internal rotor 95, therefore engaging the sheet 96 with the internal rotor 95. Further, oil is filled between the comb-shaped tooth sections of the sheet 96 and the comb-shaped tooth sections of the internal rotor 95 engaging with each other. The internal rotor 95 and the sheet 96 are basically accommodated within the internal space formed by the cover 92 and the case 93 for liquid tight sealing. In such configuration, when the internal rotor 95 rotates, the rotating device 91 generates an increasing rotating load (braking) with viscosity of the oil filled between the internal rotor 95 and the sheet 96 in proportion to an increase of a rotating speed of the internal rotor 95.

Accordingly, when the reel member 31 rotates in the direction “b” where the reel member 31 unreels the rope member 21, rotation of the reel member 31 (mating shaft portion 31c) is transferred to the internal rotor 95 via the one-way clutch 94. Further, in the same way as described in the first, second, third, and forth embodiments, the rotating device 91 generates a rotating load (braking) in accordance with a rotating speed of the internal rotor 95 (FIG. 8). Consequently, when the slide door 2 moves from the predetermined partly opened position to the fully closed position or the fully opened position, the slide door 2 is operated to open and close while the opening and closing speeds of the slide door 2 are reduced so as not to exceed a speed equivalent to the specified speed due to an effect of the rotating load of the rotating device 91.

Meanwhile, when the reel member 31 rotates in the direction “a” where the reel member 31 reels the rope member 21, the one-way clutch 94 runs idle, so that the internal rotor 95 does not rotate. Accordingly, in the same way as described in the first, second, third, and fourth embodiments, a rotating load generated in the rotating device 91 undergoes a small value due to the loss of a rotation of the one-way clutch 94 only (see FIG. 8). Consequently, when the slide door 2 moves from the fully closed position or the fully opened position to the predetermined partly opened position, the slide door 2 is operated to open and close at an approximately constant speed while not being affected by the rotating load of the rotating device 91.

As described above, in the slide door apparatus according to the fifth embodiment, the following effects are obtained in addition to the effects (1), (2), (3) of the first embodiment.

(1) In the fifth embodiment, there is no limitation of an operational rotating angle of the internal rotor 95 of the rotating device 91 (smaller than 360 degrees). Accordingly, for example, a diameter of the area (i.e., the reel portion 31a) where the rope member 21 is wound is more freely designed.

(2) In the fifth embodiment, the reel member 31 and the rotating device 91 (internal rotor 95) are axially connected directly to each other, therefore reducing an area seen when the reel member 31 and the rotating device 91 are axially projected.

In addition, the fifth embodiment may be modified as follows. In the fifth embodiment, the rotating device 91 and the reel member 31 may be radially disposed side by side with each other. In this case, transferring of rotations between the reel member 31 and the internal rotor 95 via the one-way clutch 94 is appropriately conducted by utilizing mechanical connections (such as gear connections) in the same way as the third embodiment. As the result of such a modification, axial thickness of the speed control mechanism 91 may be reduced as a whole.

In the same way as described in the fourth embodiment, the rope member 87 having its own spring force may be applied to the fifth embodiment. In this case, the biasing member (spring 32) is excluded, so that the speed control mechanism 91 is minimized in an axial direction. Consequently, the slide door apparatus as a whole is minimized.

In each of the first to the fifth embodiments, the rope member 21 and the rope member 87 may not be limited to a strip-shaped member but may be a line-type (string-type) member. Moreover, the rope member 21 may be a cable-type member or a member internally having a core material for securing strength.

In each of the first to the fifth embodiments, a system electrically opening and closing the slide door 2 may be applied. Even in this case, similar effects as manual opening and closing operations of the slide door 2 are obtained.

As explained above, the configuration of the slide door apparatus of the aforementioned embodiments, when the reel member 31, 104, 66 or 86 rotates in the direction “b” where the reel member 31, 104, 66 or 86 unreels the rope member 21 or 87, the rotating device 41, 71, 89 or 91 generates an appropriate rotating load to a rotating speed of the internal rotor 44, 74, 84 or 95. Accordingly, an increase of opening and closing speeds of the slide door 2 correlating with rotating speeds of the internal rotor 44, 74, 84 or 95 is prevented. Consequently, an obstacle may be prevented from being caught between the slide door 2 and the vehicle body 1. Meanwhile, when the reel member 31, 104, 66 or 86 rotates in the direction “a” where the reel member 31, 104, 66 or 86 reels the rope member 21 or 87, there is no or slight effect of a rotating load generated in the rotating device 41, 71, 89 or 91. Accordingly, when the slide door 2 moves from the fully closed position or the fully opened position to the predetermined partly opened position, i.e., when no obstacle may be caught between the slide door 2 and the vehicle body 1, opening and closing speeds of the slide door 2 are not reduced. Consequently, when the user manually opens and closes the slide door 2, the slide door 2 is operated to open and close at speeds as he/she intends. As a result, the user's discomfort due to a hindered movement occurring when the slide door 2 is opened and closed may be prevented.

Further, according to the slide door apparatus of the aforementioned embodiments, the reel member 31, 104, 66 or 86 is accommodated in the housing 25, 62 or 82, and the housing 25, 62 or 82 is located coaxially with the rotational axis of the reel member 31, 104, 66 or 86 and rotatably connected to one of the vehicle body 1 and the slide door 2 where the reel member 31, 104, 66 or 86 is disposed.

Accordingly, the housing 25, 62 or 82 is connected to the vehicle body 1 (support panel 12) so as to rotate coaxially with the rotational axis of the reel member 31, 104, 66 or 86. Accordingly, the housing 25, 62 or 82 is pressed by the rope member 21 or 87 to rotate even when the rope member 21 or 87 being reeled and unreeled by the reel member 31, 104, 66 or 86 interferes with the housing 25, 62 or 82 (mouth 26c). Consequently, the rope member 21 or 87 is prevented from extremely deflecting at the contact point between the rope member 21 or 87 and the housing 25, 62 or 82, therefore increasing the durability of the rope member 21 or 87.

According to the slide door apparatus of the aforementioned embodiments, the biasing force acting when the reel member 31, 104 or 66 rotates in the other direction where the reel member 31, 104 or 66 reels the rope member 21 is generated by the spring 32 locked at the first end 32a of the spring 32 to the housing 25 or 62 and locked at the second end 32b of the spring 32 to the reel member 31, 104 or 66.

According to the slide door apparatus of the aforementioned embodiments, the biasing force acting when the reel member 86 rotates in the other direction where the reel member 86 reels the rope member 87 is generated by the spring force owned by the rope member 87.

According to the slide door apparatus of the aforementioned embodiments, the rotating device 41, 71 or 89 is the pressure resistant rotating damper or the rotating device 91 is the viscosity resistant rotating damper combined with the one-way clutch 94.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A slide door apparatus for a vehicle, comprising:
a reel member adapted to be disposed at one of a vehicle body and a slide door for opening and closing a door opening formed in the vehicle body;
a rope member reeled by the reel member and adapted to be connected at a terminal end of the rope member to the other of the vehicle body and the slide door, the rope member being unreeled from the reel member when the slide door moves from a predetermined partly opened position to a fully closed position or a fully opened position so as to rotate the reel member in one direction where the reel member unreels the rope member, the rope member being reeled within the reel member in accordance with a rotation of the reel member by means of a biasing force in the other direction where the reel member reels the rope member when the slide door moves from the fully closed position or the fully opened position to the predetermined partly opened position; and
a rotating device including an internal rotor rotating in accordance with the rotation of the reel member and generating a rotating load depending on a rotating speed of the internal rotor when the reel member rotates in the one direction where the reel member unreels the rope member.

2. The slide door apparatus for the vehicle according to claim 1, wherein the reel member is accommodated in a housing, and the housing is located coaxially with a rotational axis of the reel member and rotatably connected to one of the vehicle body and the slide door where the reel member is disposed.

3. The slide door apparatus for the vehicle according to claim 2, wherein the biasing force acting when the reel member rotates in the other direction where the reel member reels the rope member is generated by a spring locked at a first end of the spring to the housing and locked at a second end of the spring to the reel member.

4. The slide door apparatus for the vehicle according to claim 1, wherein the biasing force acting when the reel member rotates in the other direction where the reel member reels a rope member is generated by a spring force owned by the rope member.

5. The slide door apparatus for the vehicle according to claim 1, wherein the rotating device is a pressure resistant rotating damper or a viscosity resistant rotating damper combined with a one-way clutch.
